(19) United States
(12) Patent Application Publication
(10) Pub. No.: US 2014/0274467 A1
(43) Pub. Date: Sep. 18, 2014

(54) Golf Ball Comprising Silicone Composition

(71) Applicant: NIKE, Inc., Beaverton, OR (US)

(72) Inventor: Thomas J. Kennedy, III, Wilbraham, MA (US)

(21) Appl. No.: 13/842,170

(22) Filed: Mar. 15, 2013

(51) Int. Cl. A63B 37/00; B29D 99/00

(52) U.S. Cl. CPC A63B 37/007; B29D 99/0042
USPC 473/371; 264/319

(57) ABSTRACT

A golf ball comprising a silicone composition and a method for making the golf ball by liquid injection molding.

### BACKGROUND

The present disclosure relates generally to a golf ball comprising a silicone composition. In particular, the disclosure is directed to a golf ball having a layer comprising polydimethylsiloxane material. The disclosure also relates to a method for making a golf ball comprising the silicone composition.

Golf balls are important sporting goods that have changed with changes in technology. Both exterior and interior structures have changed. For example, balls were first made of wood, and then by stuffing boiled, softened feathers into a leather sack. The gutta percha golf ball displaced wood and feather golf balls.

Golf balls comprising other elastic materials then were developed. For example, a golf ball having an elastic thread wound tightly around a rubber core was developed. The winding was covered with gutta percha at first, but later with balata. However, balata-covered golf balls often are damaged by imprecise club strikes. Thus, tougher covers were developed, including in particular covers comprising a Surlyn® compound or a polyurethane compound.

The interior structure of the golf ball also has advanced, with plastics and polymeric materials having properties and characteristics appropriate for manufacture of high-quality, high-performance, affordable golf balls. In particular, polymeric materials having properties and characteristics appropriate for golf ball manufacture have been developed. Such polymeric materials include polyurethanes and ionomeric materials, including highly neutralized acid polymers. Blended materials also are used to manufacture other products.

Blends of materials often are used to obtain properties and characteristics of golf balls that may not be available from a single material. Also, multi-piece or multi-layer golf balls have been manufactured.

The relative performance of golf balls having different compositions and structures also must be considered. For example, the market for golf balls includes players having skill levels ranging from novice to expert. Also, some golf ball properties and characteristics include subjective evaluations, such as the feel and ‘click’ of the ball, i.e., the sound the ball makes when struck. Because golf is played in a wide variety of environmental conditions, golf balls exhibiting properties and characteristics that very little, if at all, with changes in temperature aid in providing a consistent experience for the player. Also, the cost of manufacturing golf balls must be considered.

Therefore, there exists a need in the art for a golf ball that is easily and quickly manufactured and has excellent impact resistance and durability and other properties and characteristics that are consistent across a large temperature range.

### SUMMARY

In one aspect, the disclosure provides a golf ball that has excellent impact resistance and durability, properties and characteristics that are consistent across a large temperature range, and is easily and quickly manufactured. A golf ball described herein comprises at least 1 layer comprising a polydimethylsiloxane material. The polydimethylsiloxane material that sets in less than about 3 minutes and achieves at least about 90 percent of full physical properties of the polydimethylsiloxane material within about 10 minutes.

In another aspect, the disclosure provides a method for forming a layer of a golf ball comprising polydimethylsiloxane material. In accordance with the method, a golf ball layer comprising polydimethylsiloxane material is formed by polymerizing dimethylsiloxane polymer material in a mold by a liquid injection molding process to form polydimethylsiloxane material. Polymerization in the mold is carried out until the polydimethylsiloxane material sets.

In still another aspect, the invention provides a method for forming a golf ball layer comprising polydimethylsiloxane material by living anionic polymerization, i.e., addition polymerization, of dimethylsiloxane polymer material in a mold for a time and at a temperature sufficient to develop at least about 90 percent of the full physical properties of the polydimethylsiloxane material within 10 minutes.

In still another aspect, solid silicone rubbers may be vulcanized using aroyl-peroxide catalyst or alkyl-peroxide catalyst. Peroxide catalysts allow for high reaction rates.

In yet another aspect, silicones may be cross-linked at elevated temperature utilizing a platinum catalyst.

Other systems, methods, features, and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 shows a golf ball having aspects in accordance with this disclosure, the golf ball being of a two-piece construction;

FIG. 2 shows a second golf ball having aspects in accordance with this disclosure, the second golf ball having an inner cover layer and an outer cover layer;

FIG. 3 shows a third golf ball having aspects in accordance with this disclosure, the third golf ball having an inner core layer and an outer core layer; and

FIG. 4 shows a fourth golf ball having aspects in accordance with this disclosure, the four golf ball having an inner core layer, an outer core layer, an inner cover layer, and an outer cover layer.

### DETAILED DESCRIPTION

In one aspect, the disclosure provides a golf ball having excellent impact resistance and durability, properties and characteristics that are consistent across a large temperature range, and is easily and quickly manufactured. A golf ball described herein comprises at least 1 layer comprising polydimethylsiloxane material. The layer comprising polydimethylsiloxane material sets in less than about 3 minutes and achieves at least about 90 percent of full physical properties of the polydimethylsiloxane material within about 10 minutes.

In another aspect, the disclosure provides a method for forming a layer of a golf ball comprising polydimethylsiloxane material. In accordance with the method, a golf ball layer comprising polydimethylsiloxane material is formed by polymerizing dimethylsiloxane polymer material in a mold by a liquid injection molding (LIM) process to form polydimethylsiloxane material. Polymerization in the mold is carried out until the polydimethylsiloxane material sets.

In still another aspect, the invention provides a method for forming a golf ball layer comprising polydimethylsiloxane material by living anionic polymerization, i.e., addition polymerization, of dimethylsiloxane polymer material in a mold for a time and at a temperature sufficient to develop at least about 90 percent of the full physical properties of the polydimethylsiloxane material within 10 minutes.

The polydimethylsiloxane material also may be known as liquid silicone rubber, polydimethylsiloxane rubber, or siloxane rubber. The polydimethylsiloxane material is a soft solid that may be vulcanized, or cross-linked.

The skilled practitioner recognizes that golf balls may have any number of layers. A golf ball may be a one-piece golf ball, i.e., is a golf ball formed of one compound. Typically, however, a golf ball has plural layers, typically three, four, or five layers. Such golf balls are known as three-, four-, or five-piece golf balls. In embodiments of this disclosure, the layer comprising polydimethylsiloxane material may form any layer of a multi-piece golf ball.

The drawing figures depict four golf balls in which a layer comprising polydimethylsiloxane material may form a layer of a golf ball. For example, FIG. 1 depicts a golf ball having two-piece construction. FIG. 2 shows a second golf ball having core 230, inner cover layer 220, and outer cover layer 230. Similarly, FIG. 3 shows a third golf ball having inner core layer 330, outer core layer 320, and cover layer 310. FIG. 4 shows a fourth golf ball having inner core layer 440, outer core layer 430, inner cover layer 420, and outer cover layer 410. Typically, each layer essentially encompasses interior layers.

Golf balls having three or more layers illustrate the principle that different names may be associated with layers that have the same position in the golf ball. For example, the skilled practitioner typically identifies layer 220 as an inner cover layer and layer 320 as an outer core layer, even though each layer is the middle of three layers, because the layers may have different purposes in the golf ball design. Inner cover layer 220 may be designed to encase or protect core layer 230, whereas outer core layer 320 may be designed to contribute resilience to the core, which often is characterized as “the engine of the golf ball.” Inner cover layers 220 and 420 also may share the purpose of encasing the remainder of the inner golf ball. Thus, the name associated with a layer is less important than the properties and characteristics of that layer.

In embodiments of this disclosure, any layer or layers of the golf ball may comprise polydimethylsiloxane material. The properties and characteristics of the polydimethylsiloxane material may be adjusted by changing the composition of the dimethylsiloxane polymer material or curing conditions so that, for example, a core layer is resilient and a cover layer is durable. In accordance with the guidance provided herein, the skilled practitioner will be able to adjust the properties and characteristics of a layer comprising polydimethylsiloxane material to provide the properties and characteristics sought.

Polydimethylsiloxane is a silicone polymer having a backbone or chain of alternating silicon and oxygen molecules, and may be linear or cyclic. Silicon is capable of having four bonds, and typically, in polydimethylsiloxane, the two bonds that are not oxygen bonds are occupied with methyl groups. Other typically organic groups can be substituted for one or both of the methyl groups. For convenience, the polydimethylsiloxane materials and dimethylsiloxane polymer materials will be described herein as the methyl form, but the skilled practitioner recognizes that other organic groups, such as phenyl and vinyl, may be present at these other two bond sites, i.e., the bond sites that are not involved in the polydimethylsiloxane chain. Other structural variations are available by utilization of multifunctional reactive units. Polydimethylsiloxane rubber is a form of polydimethylsiloxane material that has long polymer chains and which may be cross-linked.

Polydimethylsiloxane material is made from four building blocks. The four building blocks, or functional units, are used in proportions appropriate to yield polydimethylsiloxane material having the required properties and characteristics. These four building blocks are classified by their functionality, i.e., the number of bonds that can be made with oxygen atoms bonded to the silicon atom. Each oxygen atom can accept one bond after displacement of the hydrogen atom associated with the oxygen atom.

The four functional units are as follows:

monofunctional units M, SiR₃OH, that permit chain termination:

difunctional units D, SiR₂(OH)₂, that form the backbone of polydimethylsiloxane material and ring compounds;

trifunctional units T, SiR(OH)₃, that produce branched molecules; and

tetrafunctional units Q, Si(OH)₄, that lead to cross-linked structures like silicates.

These functional units are combined in proportions that yield a siloxane composition having the selected properties and characteristics. For example, polymerization of D units leads to linear structures which can be capped with M units, which also are known as end-cap groups. Polymerization of D units also may lead to cyclic compounds, which are identified as Dₓ, wherein x identifies the number of silicon atoms in the ring. Further, inclusion of a T unit during polymerization of D units will introduce branched structures. Similarly, inclusion of Q units leads to cross-linked structures like silicates.

In embodiments of the disclosure, polydimethylsiloxane material typically comprises M and D units. T units may be included to introduce branched structure. The skilled practitioner recognizes that it also is possible to cross-link polydimethylsiloxane molecules at methyl groups pendant from the chain.

Thus, the properties and characteristics of the polydimethylsiloxane material may be tailored to ensure that the layer comprising the polydimethylsiloxane material provides the structure and performs the intended function of that layer of the golf ball. Dimethylsiloxane polymer materials typically are characterized by their viscosities. Dimethylsiloxane polymer material in the form of low molecular weight chains and cyclic molecules typically are fluids having low viscosity (typically less than about 1,000 cSt), whereas significantly higher molecular weight polymer materials, including gums, have viscosities at least about 1,000,000 cSt). Cyclic molecules typically have the formula Dₓ, where x is at least 3, and the linear materials have the formula MD_{y}M, where y is 0 or any positive integer. These compounds are essentially inert and are used as heat transfer fluids, lubricants, and for many other purposes. Rigid solids, or resins, include sufficient T and Q units to form the solid, which can be surface-modified with M units to increase compatibility with other materials. Polydimethylsiloxane material, or silicone rubbers, are soft solids derived from fluid dimethylsiloxane polymer materials.

Polydimethylsiloxane material is suitable for use in layers of golf balls in embodiments of this disclosure. Polydimethylsiloxane materials comprise long-chain polydimethylsiloxane molecules, and may be cross-linked. Polymerization may be carried out by curing for a time and at a temperature sufficient to yield the desired properties and characteristics. In some embodiments of the disclosure, polymerization is carried out by living anionic polymerization. Typically, cure to set is at an elevated temperature, i.e., between about 250° F. and about 450° F. (between about 121° C. and about 232° C.).

Suitable fillers include silica, typically pyrogenic silica having a BET surface area of at least about 100 m²/g and a particle size between about 10 nm and about 40 nm or precipitated silica, inactive fillers, such as quartz or diatomaceous earth, or selected grades of carbon black. Fillers typically are added to improve the otherwise poor tensile strength of silicones. However, fillers may interact with the silicone to form pseudo-vulcanizates that may form hard spots. With the guidance provided herein, the skilled practitioner can identify suitable fillers.

The performance of the golf ball is determined by the composition and arrangement of the layers of the golf ball. Typically, the core layers affect the coefficient of restitution (COR) of the golf ball, thus affecting the speed of the golf ball when struck and the distance of flight. The properties and characteristics of the core layers also typically affect the compression of the golf ball. A low compression may provide better golf ball feel at the expense of COR and flight distance.

Other configurations also are known. For example, a golf ball having hard core layers and hard, typically relatively thin, cover layers, typically may be characterized as a distance golf ball suitable for golfers having a high swing speed. Such a golf ball often has a low spin rate and may be durable. However, a golf ball having softer core layers and softer cover layers may provide better feel and yield more distance on a slow-speed strike.

The skilled practitioner recognizes that the glass transition temperature, T_{g}, of polydimethylsiloxane material is lower than the T_{g} of polybutadiene, which often is used in core layers of golf balls because it has properties and characteristics sought for golf ball cores. Therefore, a golf ball core comprising polydimethylsiloxane material may be more resilient than a golf ball core comprising polybutadiene rubber. Therefore, in embodiments of the disclosure herein, polydimethylsiloxane material is suitably used in core layers of golf balls.

Other interior layers, such as inner cover layers or intermediate layers, of golf balls also may comprise polydimethylsiloxane material in embodiments of the disclosure. The skilled practitioner recognizes that interior layers other than the core layers may affect feel, as described herein. In particular, a golf ball having three or more layers can be designed to provide better performance because such a golf ball may respond differently to strikes with different clubs. For example, softer inner layers with a softer outer cover may provide better feel and spin on short iron shots while providing good distance on longer iron shots and driver shots. Such shots use a high club head speed and so compress the softer interior layers, thus enabling the hard core layers to provide maximum distance with minimum spin.

In embodiments of the disclosure, a golf ball having excellent impact resistance and durability, properties and characteristics that are consistent across a large temperature range comprises at least 1 layer comprising polydimethylsiloxane material. The layer comprising polydimethylsiloxane material sets in less than about 3 minutes and achieves about 90 percent of full physical properties of the polydimethylsiloxane material within about 10 minutes. In embodiments of the disclosure, the polydimethylsiloxane material sets in less than about 2 minutes, typically in less than about 1 minute. In some embodiments of the disclosure, the polydimethylsiloxane material sets in less than about 50 seconds, typically less than about 40 seconds, more typically in less than about 30 seconds, and even more typically in less than about 20 seconds.

In some embodiments of the disclosure, the polydimethylsiloxane material layer is a core layer. In such embodiments, the polydimethylsiloxane material has a Shore A durometer hardness of at least about 5, typically between about 10 and about 60, and more typically between about 20 and about 40. Elongation at break of this polydimethylsiloxane material may be greater than about 150 percent, typically greater than about 300 percent, and more typically greater than about 500 percent.

Further, in embodiments of the disclosure, the polydimethylsiloxane material has a tensile strength of between about 5.0 N/mm² and about 9.0 N/mm², typically between about 6.0 N/mm² and about 8.5 N/mm², and more typically between about 7.0 N/mm² and about 8.0 N/mm². The flexural modulus is between about 500 psi and 10,000 psi, typically between about 1,000 psi and about 5,000 psi. In embodiments of the disclosure, the diameter of a core or an inner core is between about 5 mm and about 37 mm, typically between about 10 mm and about 25 mm, and more typically between about 15 mm and 20 mm. In embodiments of the disclosure, the thickness of an outer core layer may be between about 5 mm and about 10 mm, typically between about 5 mm and about 8 mm.

Other properties and characteristics also may be of interest in embodiments of the disclosure. For example, the density of the polydimethylsiloxane material typically may be between about 1.06 g/cm³ and about 1.11 g/cm³. Tear strength typically may be between about 20 N/mm and about 25 N/mm, and the dielectric constant at 50 Hz is about 2.8 Er. Rebound elasticity may be between about 58 percent and about 64 percent, and viscosity is about 190,000 cP at a shear rate of 0.9/sec and about 150,000 cP at a shear rate of about 10/sec.

In some embodiments of the disclosure, the polydimethylsiloxane material layer will be an intermediate layer such as an inner cover layer. The Shore A durometer hardness for an intermediate layer typically is between about 10 and about 95, more typically between about 20 and about 80, and even more typically between about 20 and about 60. Elongation of this polydimethylsiloxane material is greater than about 150 percent, typically greater than about 300 percent. Other typical properties and characteristics of such embodiments of the disclosure for a polydimethylsiloxane material intermediate layer may be the same as those for polydimethylsiloxane material present in a core layer. In embodiments of the disclosure, inner cover layers may have a thickness between about 0.5 mm and about 5 mm, typically between about 1 mm and about 4 mm.

In embodiments of the disclosure, the polydimethylsiloxane material layer is the outer cover layer. In some embodiments, an outer cover layer comprising polydimethylsiloxane material may be relatively thin, for example between about 0.25 mm and about 7.5 mm, typically between about 0.75 mm and about 5 mm, and more typically between about 1.25 mm and about 3.75 mm. The Shore A durometer hardness for the outer layer comprising polydimethylsiloxane material typically is between about 20 and about 95, more typically between about 40 and about 90, and even more typically between about 50 and about 85. The tensile strength of a polydimethylsiloxane rubber layer is between about 5.0 N/mm² and about 9.0 N/mm², typically between about 6.0 N/mm² and about 8.5 N/mm², and more typically between about 7.0 N/mm² and about 8.0 N/mm². Elongation at break of this polydimethylsiloxane material is greater than about 150 percent, typically greater than about 175 percent, and more typically greater than about 200 percent. The flexural modulus is between about 500 psi and 10,000 psi, typically between about 1,000 psi and about 5,000 psi.

Other typical properties and characteristics also may be of interest in embodiments of the disclosure relating to outer cover layers. For example, the density of the polydimethylsiloxane material typically may be between about 1.10 g/cm³ and about 1.20 g/cm³. Tear strength typically may be between about 12 N/mm and about 18 N/mm, and the dielectric constant at 50 Hz is about 2.8 Er. Rebound elasticity may be between about 65 percent and about 74 percent, and viscosity is about 2,000,000 cP at a shear rate of 0.9/sec and about 710,000 cP at a shear rate of about 10/sec.

The skilled practitioner recognizes that the outer cover layer is subjected to forces that often lead to damage such as scuffs, cuts, and the like. This damage is caused by club strikes, particularly mis-hits, and by collisions with objects on the course or driving range, such as trees, bushes, and signs. Therefore, the properties and characteristics are tailored to provide a tough and durable cover layer. In some embodiments of the disclosure, the polydimethylsiloxane material may be self-healing when damaged, i.e., the outer cover layer will tend to seal or re-join the edges of cuts and scuffs. This self-healing tendency may not be present, however, if material is completely removed from the golf ball, i.e., the layer may not self-seal if the distance between edges of the damage is too great.

In embodiments of the disclosure, inclusion of a polydimethylsiloxane material layer provides superior golf ball performance because the properties and characteristics of the layer may provide excellent distance, spin, and feel, for example. In embodiments of the disclosure, inclusion of a layer of polydimethylsiloxane material layer provides a preferred ‘click.’ Some compositions, typically hard compositions, used in golf ball manufacture may not produce a sound that golfers find pleasing. Often, the displeasing sound produced by these compositions is described as “too clicky.” However, inclusion of a polydimethylsiloxane material layer, particularly as an intermediate layer or as the outer cover layer, may provide a ‘click’ that is pleasingly different from and demonstrably superior to the displeasing sound emitted by other golf balls.

In embodiments of the disclosure, the dimethylsiloxane polymer material is selected from liquid dimethylsiloxane compositions that may be polymerized. In some embodiments of the disclosure, the dimethylsiloxane polymer material may be cross-linked. The dimethylsiloxane polymer material may be linear or cyclic. Typically, the dimethylsiloxane polymer material is inert and does not polymerize unless catalyst is present and the temperature is sufficiently high. In some embodiments of the disclosure, the dimethylsiloxane polymer material has the formula D_{X}, where x is between 3 and about 8, more typically between about 3 and 6. In some embodiments of the disclosure, dimethylsiloxane polymer material has the formula MD_{y}M.

Linear dimethylsiloxane polymer materials may incorporate end-caps or end blockers to limit chain length. These materials often have the formula R¹R²R³Si—O—SiR⁴R⁶R⁶, wherein R¹, R², R³, R⁴, R⁵, and R⁶ may be independently selected from a hydrocarbon group, typically alkyl, and more typically methyl, or another group that terminates addition polymerization. For example, a typical end blocker is hexamethyl-disiloxane, i.e., R¹=R²=R³=R⁴=R⁵=R⁶=methyl, which has the following structural formula:

[chemical structure]

Other typical end caps include compounds wherein one R on each silicon atom is a different group, such as propylamine (R¹=R²=R⁴=R⁵=methyl and R³=R⁶=propylamine), to yield 3-[3-(3-amino-propyl)-1,1,3,3-tetramethyl-disiloxanyl]-propylamine, which has the following structure:

[chemical structure]

Other typical end caps have the following structural formulas:

[chemical structure]

In embodiments of the disclosure, the rings of cyclic compounds, such as D₄, are opened to form linear ionic molecules, which then can be end-capped or can be linked to form longer chains that also are dimethylsiloxane polymer material. For example, D₄ can be opened in the presence of potassium hydroxide to form a linear ion, as follows:

[chemical structure]

Two opened rings can be linked, as follows:

[chemical structure]

This molecule then can be linked to a third open chain, or can be end-capped with, for example, hexamethyl-disiloxane, as follows:

[chemical structure]

where n=8. The resultant molecule is a dimethylsiloxane polymer material.

This is an equilibrium reaction in which between about 85 percent and 90 percent of the molecules are opened to linear molecules and between about 10 percent and 15 percent of the molecules remain as cyclic molecules. When one R group on each terminus is the vinyl hydrocarbon group, or H₂C═CH—, the dimethylsiloxane polymer material is called “vinyl-stopped” and has the following general formula:

[chemical structure]

In embodiments of the disclosure, the polymerization carried out is known as living anionic ring opening polymerization. In this polymerization, sec-butyllithium, CH₃CHLiCH₂CH₃, and a cyclic dimethylsiloxane polymer material such as D₃ are reacted in multiple steps to form a linear ion that is capped on one end by the sec-butyl group and on the other end by a halo-silane compound, CISiR⁷R⁸R⁹, where R⁷, R⁸, and R⁹ may be independently selected from a hydrocarbon group, typically alkyl, and more typically methyl, or another group that terminates addition polymerization, as follows:

[chemical structure]

where THF is tetrahydrofuran and R⁷, R⁸, and R⁹ are as defined.

This reaction yields an increase in viscosity as the number and length of linked molecules increases. A maximum viscosity is reached when the end cap is incorporated into the molecule, after which the viscosity reduces somewhat and remains essentially constant. Thus, it is possible to obtain a liquid dimethylsiloxane polymer material that has a viscosity appropriate for use in a liquid injection molding process. With the guidance provided herein, the skilled practitioner will be able to obtain this result. Many dimethylsiloxane polymer materials are available commercially. Commercial products typically are classified by the viscosity of the fluid.

In embodiments of the disclosure, these polymerization reactions may include cross-linking reactions. These reactions may be catalyzed, typically by a platinum catalyst or by a peroxide catalyst. Peroxide catalysts may provide high reaction rates.

In embodiments of the disclosure, peroxide catalyst typically may be an aroyl peroxide or an alkyl peroxide. Peroxide catalysts may be used alone or in combination.

Aroyl peroxide catalysts may have the following general formula:

[chemical structure]

wherein n=0, 1, 2, or 3 and R=CH₃ or Cl.

In embodiments of the disclosure, an aroyl peroxide catalyst may be dibenzoyl peroxide, di(o-methylbenzoyl)peroxide, di(2,3-dimethylbenzoyl)peroxide, and di(p-chlorobenzoyl)peroxide.

Alkyl peroxide catalysts may have the general formula R¹—O—O—R², wherein R¹ and R² are hydrocarbon groups and may be the same or different. In embodiments of the disclosure, a peroxide catalyst may be 2,5-dimethyl-2,5-bis(t-butylperoxy)hexane or di-tertiarybutyl peroxide, for example. Alkyl peroxides may be especially suitable for use with pressure, as it does not form carbonic acid. In embodiments of the disclosure, peroxide decomposition products may be removed from the polymer in known post-curing steps.

In embodiments of the disclosure, platinum catalyst is used in a cross-linking reaction, in accordance with the following reaction steps:

[chemical structure]

In embodiments of the disclosure, a golf ball layer comprising polydimethylsiloxane material is formed by polymerizing dimethylsiloxane polymer material by addition curing in a mold to form polydimethylsiloxane material. In accordance with the disclosure, liquid injection molding (LIM) may be used to form a layer comprising polydimethylsiloxane material. In embodiments of the disclosure, at least two liquid components are introduced into a mold and polymerized at an elevated temperature.

In embodiments of the disclosure involving LIM, two or more reactant or additive streams are metered to ensure that correct amounts of each stream are introduced into a mold through an injection nozzle after mixing. A static mixer often is used, and the components typically are pumped directly from drums as supplied by a manufacturer to an LIM apparatus. The apparatus may include features that ensure that the streams are kept at appropriate temperature before injection, and additional apparatus for introducing fillers, colors, and other materials, such as additives. With the guidance provided herein, the skilled practitioner will be able to obtain and configure a LIM apparatus.

Typically, the two primary streams or components are identified as A and B components in commercial products. In embodiments of the disclosure, an additive that inhibits cross-linking below a temperature may be added to a component stream together with a catalyst, and that component stream is maintained at a temperature below the inhibiting temperature. In this way, a catalyst may be blended with reactant essentially without inducing premature reaction. The commercial products may contain catalyst in either stream.

In embodiments of the disclosure, dimethylsiloxane polymer material is introduced as a first component stream or reactant stream. Typically, the second major component stream or reactant stream may include a functional curing agent and a catalyst. In embodiments of the disclosure, the curing agent is a halo-silane compound, CISiR⁷R⁸R⁹, where R⁷, R⁸, and R⁹ may be independently selected from a hydrocarbon group, typically alkyl, and more typically methyl, or another group that terminates addition polymerization.

In LIM, reactants, catalysts, curatives, fillers, and other components typically may be introduced in two streams. These streams typically are identified as a first, or “A”, component and a second, or “B” component. The A component typically may contain siloxane polymers, fillers, catalyst, and various additives. The B component typically may contain siloxane polymers, fillers, and additives, but also may contain hydrogen siloxanes and cure inhibitors. Hydrogen siloxanes are characterized by the presence of a hydrogen group on one or more silicon atoms per molecule.

In typical LIM processes that are embodiments of the disclosure, the combined A component stream and B component stream generally may comprise a vinyl-stopped polydimethylsiloxane; a low molecular weight vinyl-stopped polyorganosiloxane having vinyl on the chain, or backbone; a low molecular weight monovinyl-stopped polyorganosiloxane; platinum hydrosilylation catalyst; cure inhibitor; and silyl hydrides. The compositions also may include extending fillers, coloring agents, uv stabilizers, and other minor components.

In embodiments of the disclosure, vinyl-stopped polydimethylsiloxane may be present in an amount between about 30 parts by weight and about 90 parts by weight, more typically between about 50 parts by weight and about 75 parts by weight (pbw). The vinyl-stopped polydimethylsiloxane may have a viscosity between about 5,000 cP and about 200,000 cP, typically between about 10,000 cP and about 100,000 cP and a vinyl content of from about 0.05 wt percent to about 0.15 wt percent, based on the weight of the polydimethylsiloxane.

In embodiments of the disclosure, low molecular weight vinyl-stopped, vinyl on chain, polyorganosiloxane typically may be present in an amount of up to about 15 pbw, more typically up to about 10 pbw. Low molecular weight vinyl-stopped, vinyl on chain, polyorganosiloxane may have a viscosity of between about 100 cP and about 2,000 cP, more typically between about 200 cP and about 1,500 cP and a vinyl content of about 1 wt percent to about 2 wt percent, typically between about 1.3 wt percent and about 1.7 wt percent, based on the weight of the low molecular weight vinyl-stopped, vinyl on chain, polyorganosiloxane.

In embodiments of the disclosure, low molecular weight mono-vinyl-stopped polyorganosiloxane may be present in an amount of up to about 15 pbw, typically up to about 10 pbw. The viscosity of the low molecular weight monovinyl-stopped polyorganosiloxane is between about 300 cP and about 4,000 cP, more typically between about 500 cP and about 2,000 cP.

Platinum hydrosilylation catalyst is known to the skilled practitioner. Such catalyst may be present in an amount between about 1 pbw and about 75 pbw, typically between about 2 pbw and about 50 pbw. Cure inhibitor compound may be present in an amount between about 0.005 pbw and about 0.75 pbw, typically between about 0.01 pbw and about 0.50 pbw.

In embodiments of the disclosure, silyl hydrides are present in an amount of between about 50 pbw and about 2,000 pbw, typically between about 200 pbw to about 1,000 pbw. Other additive components may include extending fillers, coloring agents, uv stabilizers, and the like.

Two-part dimethylsiloxane polymer material kits or combinations are commercially available. For example, Elastosil® LR 3003/30A&B and Elastosil® LR 3043 and many other Elastosil® systems are available from Wacker Silicones. Similarly, suitable products are available from Shin-Etsu Silicones under the KEG-2000 and -2001 series, KEG-1950 series, and many other systems. Typically, these systems provide a selection of polydimethylsiloxane materials having a Shore A durometer hardness at a selected level, such as, for example, Shore A of about 20, Shore A of about 40, Shore A is about 60, and the like.

Additives such as fillers, coloring agents, catalysts, and the like may be introduced as part of a reactant stream, or may be introduced as a separate stream at the mixer. Embodiments of the disclosure may be catalyzed, typically with a platinum catalyst. Some embodiments of the disclosure may include compatibilizers that improve bonding between the polydimethylsiloxane material layer and compositions present in other layers of the golf ball. In embodiments of the disclosure, compatibilizers may include maleic anhydride and amino silanes.

In some embodiments of the disclosure, the dimethylsiloxane polymer material is polymerized in a mold for a time and at a temperature sufficient to set the polydimethylsiloxane material within less than about 3 minutes and to develop at least about 90 percent of the selected full physical properties and characteristics of the polydimethylsiloxane material within 10 minutes. In some embodiments of the disclosure, the conditions are sufficient to develop at least about 95 percent of the selected full physical properties and characteristics within 10 minutes. In some embodiments of the disclosure, the selected physical properties and characteristics achieve the selected level within 5 minutes. In other embodiments of the disclosure, the selected physical properties and characteristics achieve the selected level within 3 minutes.

Although the polydimethylsiloxane material has many properties and characteristics that can be measured, properties and characteristics that are relevant to the performance of the polydimethylsiloxane material are selected for measurement. In embodiments of the disclosure, the selected physical properties are selected from the group consisting of flexural modulus, tensile strength, elongation at break, Shore A durometer hardness, flexural modulus, density, tear strength, dielectric constant at 50 Hz, rebound elasticity, and viscosity at a shear rate of 0.9/sec and at a shear rate of about 10/sec.

The skilled practitioner recognizes that curing may continue after demolding, so the time in the mold may be less than the time required to achieve the required percentage of full physical properties. Thus, the time in mold typically is shorter than the 10 minute period, 5 minute period, or 3-minute period it takes to develop the required percentage of full physical properties and characteristics. The skilled practitioner recognizes that the dimethylsiloxane polymer material need only be polymerized to a degree sufficient to set the polymer, i.e., to achieve a degree of polymerization that ensures that the molded article retains its shape and can be processed when removed from the mold.

Thus, in embodiments of the disclosure, the time in mold may be less than about 3 minutes, typically less than about 2 minutes, and more typically less than about 1 minute. In embodiments of the disclosure, the time in mold may be less than about 50 seconds, typically less than about 40 seconds, more typically less than about 30 seconds, and even more typically less than about 20 seconds.

In embodiments of the disclosure, the temperature in the mold may be between about 250° F. and about 450° F. (about 121° C. and about 232° C.), typically between about 275° F. and 350° F. (about 135° C. and about 176° C.). With the guidance provided herein, the skilled practitioner will be able to establish a suitable molding temperature and a sufficient time in mold.

In embodiments of the disclosure, the polydimethylsiloxane material includes a reactive hydroxyl group. The reactive hydroxyl group may be part of an end cap group or may be pendant from a silicon atom in place of a methyl group. This reactive hydroxyl group typically does not react to further extend polydimethylsiloxane material chain length, but may react with an isocyanate group to form a pseudo-urethane compound. The pseudo-urethane compound is tough and tear resistant. In embodiments of the disclosure, the pseudo-urethane compound is added to any layer comprising polydimethylsiloxane material. In embodiments of the disclosure, the pseudo-urethane compound is present in a polydimethylsiloxane material in a concentration of between about 0.5 wt percent and about 50 wt percent, typically between about 1 wt percent and about 20 wt percent, and more typically between about 1 wt percent and about 10 wt percent.

In embodiments of the disclosure, polyurethane may be made by reaction of poly(tetramethylene ether)glycol (about 100 pbw), 1,4-butanediol (about 10 pbw), and methylene diphenyl 4,4′-diisocyanate in about stoichiometric quantity to react with the glycol and diol components.

In accordance with this disclosure, layers of the golf ball other than the at least one layer comprising polydimethylsiloxane material are other typical materials used in golf balls. Other layers of the golf ball of the disclosure may have any composition and any construction. That is, the golf ball may have at least 2 pieces or layers and the layers may have any thicknesses. Thus, in embodiments of the disclosure, a golf ball may have at least 2 layers or pieces, typically has between 3 and 7 layers or pieces, and more typically comprises between 3 and 5 pieces or layers. Each layer may have any thickness.

The construction of a golf ball made according to the present method is not limited to embodiments mentioned with specificity herein. For example, a golf ball in accordance with this disclosure may generally take any construction, such as a conforming or non-conforming construction. Conforming golf balls are golf balls which meet the Rules of Golf as approved by the United States Golf Association (USGA). The skilled practitioner recognizes that these rules include regulation of size, weight, and flight speed when struck in a prescribed manner.

In embodiments of the disclosure not having a polydimethylsiloxane material outer cover layer, the outer cover layer may comprise a durable, tough, and scuff-resistant composition. Many candidate compositions, such as polyurethane and ionomers, are known. Any composition may be used as an outer cover layer.

In embodiments of the disclosure, the golf ball may have an internal construction comprising core layers, intermediate layers, and cover layers. The core layers may comprise an inner core layer and other core layers. Also, there may be one or more intermediate layers, sometimes called mantle layers, and the cover also may comprise many layers, including an inner cover layer and an outer cover layer.

The inner core may comprise a thermoplastic material, a thermoset material, or a combination of both. Indeed, any interior layer may be a thermoplastic material, a thermoset material, or a combination thereof. Typically, a golf ball would have a dimple pattern in at least the outer cover layer. Also, the golf ball may be coated with hardeners, sealants, paints, and other protective or decorative compositions, and may be printed with informative or decorative information. With the guidance provided herein, the skilled practitioner can identify compositions and a construction suitable for a golf ball.

For example, thermoplastic polyurethanes (TPUs) are compositions suitably used in various aspects of golf ball construction and manufacture. As the skilled practitioner recognizes, thermoplastic polyurethanes are generally made up of (1) a long chain polyol, (2) a relatively short chain extender, and (3) a diisocyanate. There are few limitations on the polyols, chain extenders, and diisocyanates that will form thermoplastic polyurethane generally suitable for forming the cover layer or another layer of a golf ball. In particular, a thermoplastic polyurethane cover layer may be toughened, because thermoplastic polyurethanes may lack strain resistance and may be prone to scuffing.

One component of a thermoplastic polyurethane is a long-chain polyol. The long chain polyol (“the polyol”) may generally be a polyester polyol or a polyether polyol. Accordingly, the thermoplastic polyurethane may be either general type of polyurethane: a polyether-based polyurethane or a polyester-based polyurethane, or mixtures thereof.

The long chain polyol typically may be a polyhydroxy compound having a typical molecular weight between 250 and 4,000. Suitable long chain polyols may generally include linear polyesters, polyethers, polycarbonates, polylactones (e.g., ε-caprolactone), and mixtures thereof. In addition to polyols having hydroxyl terminal groups, the polyol may include carboxyl, amino, or mercapto terminal groups.

Polyester polyols typically are produced by the reaction of dicarboxylic acids and diols or an esterifiable derivative thereof. Examples of suitable dicarboxylic acids include succinic acid, glutaric acid, adipic acid, suberic acid, azelaic acid, sebacic acid, decanedicarboxylic acid, maleic acid, fumaric acid, phthalic acid, isophthalic acid, and terephthalic acid. Examples of suitable diols include ethanediol, diethylene glycol, 1,2- and 1,3-propanediol, dipropylene glycol, 1,4-butanediol, 1,5-pentanediol, 1,6-hexanediol, 1,10-decanediol, glycerine and trimethylolpropanes, tripropylene glycol, tetraethylene glycol, tetrapropylene glycol, tetramethylene glycol, 1,4-cyclohexane-dimethanol, and the like. Both of the dicarboxylic acids and diols can be used individually or in mixtures to make specific polyesters in the practice applications.

Polyether polyols may be prepared by the ring-opening addition polymerization of an alkylene oxide with an initiator of a polyhydric alcohol. Examples of suitable polyether polyols are polypropylene glycol (PPG), polyethylene glycol (PEG), polytetramethylene ether glycol (PTMEG). Block copolymers such as combinations of polyoxypropylene and polyoxyethylene glycols, poly-1,2-oxybutylene and polyoxyethylene glycols, polytetramethylene-etherglycol (PTMEG), poly-1,4-tetramethylene and polyoxyethylene glycols are also typically used.

Polycarbonate polyols may be made through a condensation reaction of diols with phosgene, chloroformic acid ester, dialkyl carbonate, or diallyl carbonate. Examples of diols in the suitable polycarbonate polyols of the cross-linked thermoplastic polyurethane elastomers are ethanediol, diethylene glycol, 1,3-butanediol, 1,4-butanediol, 1,6-hexanediol, neopentylglycol, and 1,5-pentanediol.

TPU also typically contains a relatively short chain extender. Suitable short chain extenders have at least two reaction sites with isocyanates, i.e., has two moieties that each react with isocyanate, and having a molecular weight of less than about 450.

Suitable chain extenders may include the common diols, such as ethylene glycol, diethylene glycol, triethylene glycol, propylene glycol, dipropylene glycol, tripropylene glycol, 1,3-propanediol, 1,4-butanediol, 1,6-hexanediol, 1,10-decanediol, neopentyl glycol, dihydroxyethoxy hydroquinone, 1,4-cyclo-hexanedimethanol, 1,4-dihydroxycyclohexane, and the like. Minor amounts of cross-linking agents such as glycerine, trimethylolpropane, diethanolamine, and triethanolamine may be used in conjunction with the diol chain extenders.

The diisocyanate component typically is an organic isocyanate. The isocyanate may include any of the known aromatic, aliphatic, and cycloaliphatic di- or poly-isocyanates. Examples of suitable isocyanates include: 2,2′-, 2,4′-, and particularly 4,4′-diphenylmethane diisocyanate (MDI), and isomeric mixtures thereof; polyphenylene polymethylene polyisocyanates(poly-MDI, PMDI); 2,4- and 2,6-toluene diisocyanates, and isomeric mixtures thereof such as an 80:20 mixture of the 2,4- and 2,6-isomers (TDI); the saturated, isophorone diisocyanate; 1,4-diisocyanatobutane; 1,5-diisocyanatopentane; 1,6-diisocyanatohexane; 1,4-cyclohexane diisocyanate (HDI); cycloaliphatic analogs of PMDI; and the like. Also, biurets, such as polyisocyanates based on HDI, also are suitable.

The skilled practitioner recognizes that the stoichiometric ratio of isocyanate moieties to hydroxyl moieties in TPU, also known as the stoichiometric NCO index, is 1:1. However, for various reasons, including completeness of reaction, avoidance of deleterious residual materials in product, avoiding waste, and the like, the stoichiometric ratio often is not used. Typically, TPU products have an NCO index, often called simply the index, of at least about 0.95, and more typically between about 0.98 and 1.50. Quantities of isocyanate moieties yielding an index above 1.50 typically provide no benefit. The TPU may be cross-linked in any way known to the skilled practitioner.

For example, the skilled practitioner recognizes that the reaction product of isocyanate and hydroxyl moieties is a urethane. However, isocyanate also is reactive with amines, with the reaction product forming a urea. Therefore, in addition to the common diol chain extenders, diamines and amino alcohols may also be used to make thermoplastic polyurethane. Examples of suitable diamines include aliphatic, cycloaliphatic, or aromatic diamines. In particular, a diamine chain extender may be ethylene diamine, hexamethylene diamine, 1,4-cyclohexylene diamine, benzidine, toluene diamine, diaminodiphenyl methane, the isomers of phenylene diamine or hydrazine. Aromatic amines may also be used, such as MOCA (4,4′-methylene-bis-o-chloroaniline), M-CDEA (4,4′-methylenebis(3-chloro-2,6-diethyl-aniline)). Examples of suitable amino alcohols, which can result in both urea and urethane structures, include ethanol amine, N-methylethanolamine, N-butylethanolamine, N-oleylethanolamine, N-cyclohexylisopropanolamine, and the like. Mixtures of various types of chain extenders may also be used to form the cross-linked thermoplastic polyurethane.

Optionally, the thermoplastic polyurethane may include further components such as fillers and/or additives. Fillers and additives may be used based on any of a variety of desired characteristics, such as enhancement of physical properties, UV light resistance, and other properties. For example, to improve UV light resistance, the thermoplastic polyurethane may include at least one light stabilizer. Light stabilizers may include hindered amines, UV stabilizers, or a mixture thereof.

Inorganic or organic fillers can be also added to the thermoplastic polyurethane. Suitable inorganic fillers may include silicate minerals, metal oxides, metal salts, clays, metal silicates, glass fibers, natural fibrous minerals, synthetic fibrous minerals, or a mixture thereof. Suitable organic fillers may include carbon black, fullerene and/or carbon nanotubes, melamine colophony, cellulose fibers, polyamide fibers, polyacrylonitrile fibers, polyurethane fibers, polyester fibers based on aromatic and/aliphatic dicarboxylic acid esters, carbon fibers or a mixture thereof. The inorganic and organic fillers may be used individually or as a mixture thereof. The total amount of the filler may be from about 0.5 to about 30 percent by weight of the polyurethane components.

Flame retardants may also be used to improve the flame resistance of the thermoplastic polyurethane. Suitable flame retardants may include organic phosphates, metal phosphates, metal polyphosphates, metal oxides (such as aluminum oxide hydrate, antimony trioxide, arsenic oxide), metal salts (such as calcium sulfate, expandable graphite), and cyanuric acid derivatives (such as melamine cyanurate). These flame retardants may be used individually or as a mixture thereof, and the total amount of the flame retardant may be from about 10 percent to about 35 percent by weight of the polyurethane components.

To improve toughness and compression rebound of layers in which these properties are preferred, the cross-linked thermoplastic polyurethane elastomer may include at least one dispersant, such as a monomer or oligomer comprising unsaturated bonds. Examples of suitable monomers include styrene, acrylic esters; suitable oligomers include di- and tri-acrylates/methacrylates, ester acrylates/methacrylates, and urethane or urea acrylates/methacrylates.

Particularly when a polyurethane elastomer is used as an outer cover layer, the layer also may include at least one white pigment to aid in better visibility. The white pigment may be selected from the group consisting of titanium dioxide, zinc oxide, and a mixture thereof. Pigments or dyes of other colors may serve equally well, particularly for non-white balls or interior layers such as layers under a transparent or translucent outer cover layer. For example, polydimethylsiloxane material in accordance with this disclosure can be clear and approaches water-white. Thus, a colored TPU inner cover layer covered with a polydimethylsiloxane material outer cover layer may be attractive. With the guidance provided herein, the skilled practitioner can identify suitable additives.

In embodiments of the disclosure, other materials of construction may be selected from the following groups: (1) thermoplastic materials selected from the group consisting of ionomer resin, highly neutralized acid polymer composition, polyamide resin, polyester resin, polyurethane resin and a mixture thereof; or (2) thermoset materials selected from the group consisting of polyurethane elastomer, polyamide elastomer, polyurea elastomer, diene-containing polymer (such as polybutadiene), cross-linked metallocene catalyzed polyolefin, silicone, and a mixture thereof. This list of materials is exemplary and not all-inclusive. Any suitable material of construction may be used.

For example, in embodiments where the core construction is multilayered, the choice of the material making up an inner core layer, such as inner core layer 330 of FIG. 3 or inner core layer 440 of FIG. 4, is not particularly limited. The material making up the inner core layer may be selected from the following groups: (1) thermoplastic materials selected from the group consisting of ionomer resin, highly neutralized acid polymer composition, polyamide resin, polyester resin, polyurethane resin and a mixture thereof; or (2) thermoset materials selected from the group consisting of polyurethane elastomer, polyamide elastomer, polyurea elastomer, diene-containing polymer (such as polybutadiene), cross-linked metallocene catalyzed polyolefin, silicone, and a mixture thereof.

Among the various thermoplastic and thermoset materials, ionomer resin or highly neutralized acid polymer composition may comprise inner core layer in particular embodiments. For example, Surlyn®, HPF 1000, HPF 2000, HPF AD1027, HPF AD1035, HPF AD1040, and a mixture thereof, all produced by E. I. DuPont de Nemours and Company, may be used.

An inner core layer may be made by a fabrication method such as hot-press molding or injection molding. The diameter of an inner core layer may be in a range of about 10 millimeters to about 37 millimeters. The dimensions of layers and the properties and characteristics of those layers may be different.

In certain embodiments, if the inner core layer is made from a thermoplastic material, then the outer core layer, such as outer core layer 320 of FIG. 3 or outer core layer 430 of FIG. 4, typically may be made from a thermoset material. In particular, an outer core layer may comprise polyurethane elastomer, polyamide elastomer, polyurea elastomer, diene-containing polymer (such as polybutadiene), cross-linked metallocene catalyzed polyolefin, and a mixture thereof. In embodiments, the outer core layer may comprise polybutadiene.

In some embodiments, a core layer typically may comprise 1,4-cis-polybutadiene in order to achieve superior resiliency performance. Specifically, 1,4-cis-polybutadiene may be used as a base material for an outer core layer, and mixed with other ingredients. Generally, however, 1,4-cis-polybutadiene may be at least 50 parts by weight, based on 100 parts by weight of the composition of the outer core layer.

Other additives, such as a cross-linking agent and a filler with a greater specific gravity typically may further be added to the composition of the outer core layer. Cross-linking agents may be selected from the group consisting of zinc diacrylate, magnesium acrylate, zinc methacrylate, and magnesium methacrylate. In particular embodiments, zinc acrylate may be used in order to achieve increased resilience.

To increase specific gravity, a suitable filler may be added in the rubber composition of the core layer. The filler may be zinc oxide, barium sulfate, calcium carbonate, and magnesium carbonate. Other fillers, such as a metal powder with a greater specific gravity, such as tungsten, may also be used. By means of adjusting the amount of filler, the specific gravity of the outer core layer may be controlled. The outer core layer also may have a surface Shore D hardness of 30 to 75.

Alternatively, the inner core layer typically may comprise the aforementioned thermoset material while the outer core layer typically may comprise the thermoplastic material, or any combination thereof. For example, inner core layer 330 of FIG. 3 or inner core layer 440 of FIG. 4 may comprise a highly neutralized acid polymer composition. The suitable highly neutralized acid polymer composition includes HPF resins such as HPF1000, HPF2000, HPF AD1027, HPF AD1035, HPF AD1040, all produced by E. I. DuPont de Nemours and Company.

Suitable highly neutralized acid polymer compositions for use in forming inner core layers 330 and 440 may comprise a highly neutralized acid polymer composition and optionally additives, fillers, and/or melt flow modifiers. The acid polymer is neutralized to 70% or higher, including up to 100%, with a suitable cation source, such as magnesium, sodium, zinc, or potassium.

Suitable additives and fillers include, for example, blowing and foaming agents, optical brighteners, coloring agents, fluorescent agents, whitening agents, UV absorbers, light stabilizers, defoaming agents, processing aids, mica, talc, nanofillers, antioxidants, stabilizers, softening agents, fragrance components, plasticizers, impact modifiers, acid copolymer wax, surfactants; inorganic fillers, such as zinc oxide, titanium dioxide, tin oxide, calcium oxide, magnesium oxide, barium sulfate, zinc sulfate, calcium carbonate, zinc carbonate, barium carbonate, mica, talc, clay, silica, lead silicate, and the like; high specific gravity metal powder fillers, such as tungsten powder, molybdenum powder, and the like; regrind, i.e., inner core material that is ground and recycled; and nano-fillers. Suitable melt flow modifiers include, for example, fatty acids and salts thereof, polyamides, polyesters, polyacrylates, polyurethanes, polyethers, polyureas, polyhydric alcohols, and combinations thereof.

Inner core layer 330 of FIG. 3 or inner core layer 440 of FIG. 4 typically may be made by a fabrication method such as hot-press molding or injection molding. In embodiments, the diameter of inner core layer 330 or inner core layer 440 may be in a range of about 19 millimeters to about 30 millimeters. To protect thermoplastic inner core layer 330 or inner core layer 440 during a core-forming process, outer core layer 320 of FIG. 3 or outer core layer 430 of FIG. 4 may have a thickness of from about 5 millimeters to about 8 millimeters and may have a volume which is greater than any other layers of golf ball 100.

The material making up outer core layer 320 or 430 typically may be thermoset material selected from the group consisting of polyurethane elastomer, polyamide elastomer, polyurea elastomer, diene-containing polymer (such as polybutadiene), cross-linked metallocene catalyzed polyolefin, silicone, and a mixture thereof. Outer core layer 320 or outer core layer 430 typically may be made by cross-linking a polybutadiene rubber composition. When other rubber is used in combination with a polybutadiene, it is typical that polybutadiene is included as a principal component. Specifically, a proportion of polybutadiene in the entire base rubber is typically equal to or greater than about 50 percent by weight, and particularly typically equal to or greater than about 80 percent by weight. A polybutadiene having a proportion of cis-1,4 bonds of equal to or greater than about 60 mol percent, and further, equal to or greater than about 80 mol percent, is typical.

Cis-1,4-polybutadiene may be used as the base rubber and mixed with other ingredients. The amount of cis-1,4-polybutadiene typically may be at least about 50 parts by weight, based on 100 parts by weight of the rubber compound. Various additives may be added to the base rubber to form a compound. The additives may include a cross-linking agent and a filler. The cross-linking agent typically may be zinc diacrylate, magnesium acrylate, zinc methacrylate, or magnesium methacrylate. In some embodiments, zinc diacrylate may provide advantageous resilience properties. The filler may be used to increase the specific gravity of the material. The filler may include zinc oxide, barium sulfate, calcium carbonate, or magnesium carbonate. In some embodiments, zinc oxide may be selected for its advantageous properties. Metal powder, such as tungsten, may alternatively be used as a filler to achieve a desired specific gravity.

Often, a polybutadiene synthesized using a rare earth element catalyst typically is used. By using this polybutadiene, excellent resilience performances of golf balls 100, 200, 300, and 400 can be achieved. Examples of rare earth element catalysts include lanthanum series rare earth element compound, organoaluminum compound, and alumoxane and halogen containing compound. A lanthanum series rare earth element compound is typical. Polybutadiene obtained by using lanthanum rare earth-based catalysts usually employ a combination of lanthanum rare earth (atomic number of 57 to 71) compounds, but particularly typical is a neodymium compound.

The skilled practitioner recognizes that, for each of the above listed reactants, any particular embodiment of a specific reactant may be mixed and matched with any other specific embodiment of another reactant according to the general formulation for thermoplastic polyurethane. Furthermore, any reactant may generally be used in combination with other reactants of the same type, such that any list herein may be assumed to include mixtures thereof, unless otherwise specified.

Outer core layer 320 or outer core layer 430 typically is made by a hot-press molding process. Suitable vulcanization conditions include a vulcanization temperature of between about 265° F. and about 375° F. (about 130° C. and about 190° C.) and a vulcanization time of between 5 and 20 minutes. To obtain the desired rubber cross-linked body for use as the core in the present invention, the vulcanizing temperature typically is at least about 285° F.) about 140° C.).

When outer core layer 320 or outer core layer 430 is produced by vulcanizing and curing the rubber composition in the above-described way, advantageous use may be made of a method in which the vulcanization step is divided into two stages. The outer core layer material is placed in an outer core layer-forming mold and subjected to initial vulcanization so as to produce a pair of semi-vulcanized hemispherical cups, and then a prefabricated inner core layer is placed in one of the hemispherical cups and is covered by the other hemispherical cup, in which state complete vulcanization is carried out.

The surface of inner core layer 330 or inner core layer 440 placed in the hemispherical cups may be roughened before the placement to increase adhesion between inner core layer 330 and outer core layer 320 or between inner core layer 440 and outer core layer 430. In some embodiments, the inner core layer surface is pre-coated with an adhesive or pre-treated with chemical(s) before placing inner core layer 330 or inner core layer 440 in the hemispherical cups to enhance the durability of the golf ball and enable a high rebound.

Inner cover layer 220 of FIG. 2 or 420 of FIG. 4 of a golf ball described herein may comprise a thermoplastic material. The thermoplastic material of inner cover layer 220 or inner cover layer 420 typically comprises at least one of an ionomer resin, a highly neutralized acid polymer composition, a polyamide resin, a polyurethane resin, a polyester resin, or a combination thereof. In some embodiments, inner cover layer 220 or inner cover layer 420 comprises the same type of cross-linked thermoplastic polyurethane as outer cover layer 110 of FIG. 1, outer cover layer 210 of FIG. 2, outer cover layer 310 of FIG. 3, or outer cover layer 410 of FIG. 4. Inner cover layer 220 or inner cover layer 420 also may comprise a cross-linked thermoplastic polyurethane composition. For example, in some embodiments, inner cover layer 220 or inner cover layer 420 may comprise a cross-linked but not over-indexed polyurethane, or may comprise yet another uncross-linked thermoplastic polyurethane different from outer cover layer 110, outer cover layer 210, outer cover layer 310, or outer cover layer 410, while in some embodiments, inner cover layer 220 or inner cover layer 420 comprises a different material from outer cover layer 110, outer cover layer 210, outer cover layer 310, or outer cover layer 410.

Inner cover layer 220 and inner cover layer 420 typically have thicknesses of less than about 2 millimeters. In some embodiments, inner cover layer 220 and inner cover layer 420 have thicknesses of less than about 1.5 millimeters. In some embodiments, inner cover layer 220 and inner cover layer 420 have thicknesses of less than about 1 millimeter. Although inner cover layer 220 is relatively thin compared to the other layers of golf ball 200 and inner cover layer 420 is relatively thin compared to the other layers of golf ball 400, it typically has the highest surface Shore D hardness among all layers.

In embodiments of the disclosure, compatibilizers may be added to any layer of the golf ball to ensure good bonding between layers. Maleic anhydride may be used as compatibilizer in embodiments of the disclosure. Further, any layer of an inner ball may be selected to withstand the processing conditions in the LIM mold and the contact with polymerized polydimethylsiloxane material. Similarly, a polydimethylsiloxane material layer must be able to withstand the processing conditions required to form the other material layer. With the guidance provided herein, the skilled practitioner will be able to design suitable arrangements of materials in the layers of a golf ball.

In embodiments of the disclosure, compression of the polydimethylsiloxane material layer will remain constant with change in temperature. This is in contrast to other materials, such as ZDA-crosslinked PBR, which becomes softer as temperature increases. Thus, a golf ball comprising polydimethylsiloxane material in embodiments of the disclosure may have less variability of the compression property with temperature than other golf balls.

Thus, in embodiments of the disclosure, the compositions named herein and other compositions that may be available for golf ball construction and manufacture may be used in combination with at least 1 layer comprising polydimethylsiloxane material. The layer comprising polydimethylsiloxane material contributes many valuable properties and characteristics to the golf ball. For example, a golf ball comprising polydimethylsiloxane material as an inner layer may have a ‘click’ sound when struck that is pleasingly different from and demonstrably superior to the ‘click’ from other golf balls.

Golf balls including embodiments of the disclosure are quickly and easily made by proven techniques. Dimethylsiloxane polymer material can be polymerized to form an inner core layer surrounding which core layer the remainder of the golf ball can be formed using known techniques. Similarly, dimethylsiloxane polymer material can be polymerized by LIM methods around an inner ball having any number of layers of other materials, and then other layers of other materials can be formed using manufacturing techniques suitable for the composition. Compatibilizers are added to the dimethylsiloxane polymer material, or to the other layers, to ensure good adhesion between the layer comprising polydimethylsiloxane material and the other materials.

Polydimethylsiloxane material is durable and impact-resistant. Polydimethylsiloxane material also is transparent and essentially water-white. Therefore, a layer of polydimethylsiloxane material may be used under a clear cover layer or under a clear coating to provide an attractive depth of appearance to the surface of a golf ball. Because polydimethylsiloxane material may be colored or dyed to provide a colored composition that may be transparent or may not be transparent, a layer comprising a colored polydimethylsiloxane material may provide an attractive appearance under a clear layer. A colored layer also could be used to identify balls from a particular manufacturer.

Polydimethylsiloxane material of embodiments of the disclosure is different from solid silicone balls often used by jugglers and in other amusements. Such juggling balls typically are hand-made to have a specific weight and size. Such juggling balls typically comprise similar materials but are not tuned to work in a golf ball.

Embodiments of the disclosure in which LIM is used to form a layer of a golf ball comprising polydimethylsiloxane material may be economically sound and ecologically sensitive. The LIM method produces golf ball layers with significantly less waste than other silicone forming processes, thus saving money and protecting the environment. Reducing waste is important because polydimethylsiloxane material of embodiments of the disclosure and other silicone products are not thermoplastics, and so they may be difficult to recycle and re-use waste.

Golf balls that include a polydimethylsiloxane material layer in accordance with this disclosure provide superior performance. The polydimethylsiloxane material is a soft yet durable composition that is quickly manufactured. Importantly, the properties and characteristics of polydimethylsiloxane material essentially do not change with temperature. Thus, the performances of golf ball embodiments of the disclosure are consistent with changes in temperature.

Molds in which LIM polymerization is carried out also may be more easily made and more economically made than molds for other silicone polymerization method. Because the reactants are essentially non-reactive liquids having relatively low viscosity at typical handling temperatures, golf ball performance is constant even if temperature changes.

As used herein, unless otherwise stated, properties and characteristics are measured as follows:
A. Compression deformation: The compression deformation herein indicates the deformation amount of the ball, or any portion thereof, under a force; specifically, when the force is increased to become 130 kg from 10 kg, the deformation amount of the ball or portion thereof under the force of 130 kg reduced by the deformation amount of the ball or portion thereof under the force of 10 kg is the compression deformation value of the ball or portion thereof.
B. Hardness: Hardness of a material is measured on a plaque in accordance with ASTM D-2240. Hardness of a golf ball layer is measured generally in accordance with ASTM D-2240, but is measured on the land area of a curved surface of a molded ball.
C. Method of measuring COR: A golf ball for test is fired by an air cannon at an initial velocity of 40 m/sec, and a speed monitoring device is located over a distance of 0.6 to 0.9 meters from the cannon. The golf ball strikes a steel plate positioned about 1.2 meters away from the air cannon and rebounds through the speed-monitoring device. The return velocity divided by the initial velocity is the COR.
D. Flexural modulus: Measured in accordance with ASTM D-790.
E. Dielectric constant is determined by DIN VDE 0303.
F. Elongation at break is determined by DIN 53504S1.
G. Rebound elasticity is determined under DIN 53512.
H. Tensile strength is determined under DIN 53504S1.
I. Viscosity is determined under DIN 53019.
J. Density is determined under ISO 1183-1A.
K. Tear strength is determined under ASTM D-624B.

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

What is claimed is:

1. A golf ball having layers comprising at least one layer comprising polydimethylsiloxane material that sets in less than about 3 minutes and achieves at least about 90 percent of full physical properties within about 10 minutes.

2. The golf ball of claim 1 wherein the at least one layer is a core layer.

3. The golf ball of claim 2 wherein the Shore A hardness of the at least one layer is between about 10 and about 60.

4. The golf ball of claim 1 wherein the at least one layer is an intermediate layer.

5. The golf ball of claim 4 wherein the Shore A hardness of the at least one layer is between about 20 and about 60.

6. The golf ball of claim 1 wherein the at least one layer is an outer cover layer.

7. The golf ball of claim 6 wherein the Shore A hardness of the at least one layer is between about 50 and about 85.

8. A method for forming a layer of a golf ball comprising polydimethylsiloxane material, the method comprising
introducing dimethylsiloxane polymer material into a mold in a LIM molding process,
polymerizing the dimethylsiloxane polymer material to form polydimethylsiloxane material that is set in less than about 3 minutes in the mold and to develop about 90 percent of the full physical properties within about 10 minutes.

9. The method of claim 8 wherein the dimethylsiloxane polymer material is polymerized in the presence of platinum catalyst.

10. The method of claim 8 wherein the dimethylsiloxane polymer material is polymerized in the presence of a peroxide catalyst.

11. The method of claim 10 wherein the peroxide catalyst is an aroyl peroxide.

12. The method of claim 10 wherein the peroxide catalyst is an alkyl peroxide.

13. The method of claim 10 wherein the peroxide catalyst is a blend comprising an aroyl peroxide and an alkyl peroxide.

14. A method for forming a layer of a golf ball comprising polydimethylsiloxane material, the method comprising
introducing dimethylsiloxane polymer material into a mold,
polymerizing dimethylsiloxane polymer material by addition curing for a time and at a temperature sufficient to set the polydimethylsiloxane material in less than about 3 minutes and to develop about 90 percent of the full physical properties within about 10 minutes.

15. The method of claim 14 wherein the layer of the golf ball has a Shore A durometer hardness of between about 10 and about 60.

16. The method of claim 15 wherein the layer of the golf ball has a Shore A durometer hardness of between about 20 and about 60.

17. The method of claim 14 wherein the layer of the golf ball has a Shore A durometer hardness of between about 50 and about 85.

18. The method of claim 14 wherein the dimethylsiloxane polymer material is polymerized in the presence of platinum catalyst.

19. The method of claim 18 wherein the layer of the golf ball has a Shore A durometer hardness of between about 10 and about 60.

20. The method of claim 18 wherein the layer of the golf ball has a Shore A durometer hardness of between about 50 and about 85.
